(19) United States
(12) Patent Application Publication
(10) Pub. No.: US 2023/0263130 A1
(43) Pub. Date: Aug. 24, 2023

(54) HABITAT WITH THERMOCHROMIC MATERIAL

(71) Applicant: CENTRAL GARDEN & PET COMPANY, Walnut Creek, CA (US)

(72) Inventors: Alexander CHIRBAN, Wauwatosa, WI (US); Andrew HUDSON, Mukwonago, WI (US)

(21) Appl. No.: 18/173,360

(22) Filed: Feb. 23, 2023

Related U.S. Application Data
(60) Provisional application No. 63/268,404, filed on Feb. 23, 2022.

(51) Int. Cl. A01K 1/035

(52) U.S. Cl. CPC A01K 1/035

(57) ABSTRACT

The present invention is directed at the use of thermochromic material that can be utilized within a reptile cage or habitat that can provide an indication of the temperature therein. More particularly, components within the reptile cage are selectively coated with a thermochromic material that provides an indication of surface temperature at one or more selected locations.

### FIELD

The present invention is directed at the use of thermochromic material that can be utilized within a reptile cage or habitat that can provide an indication of the temperature therein. More particularly, components within the reptile cage are selectively coated with a thermochromic material that provides an indication of surface temperature at one or more selected locations.

### BACKGROUND

Decorations perform a function for reptile hobbyists as they provide an area for a reptile to bask under a heat lamp to thermoregulate their body temperature. Generally, this décor is a rock, wood, or a sculpted resin piece made to look like a natural or artificial sculpture. For example, such décor may present itself as a log, cave, or skull. The decoration piece is also typically exposed to an artificial heat source such as a heat lamp, ceramic heat emitter, or infrared heat projector.

The reptile animal then receives heat from above as well as below from the reflected heat released by the décor. Hobbyists typically use thermometers to measure the temperature of the reptile environment to determine if the level of heat is appropriate to the reptile. In addition, hobbyists will monitor the heat at selected locations in the reptile environment to ensure that no one location, or the surface at any selected location, is outside of a recommended temperature range. These may involve placing a temperature sensor at the spot or using an infrared heat “gun” to measure the temperature at a distance.

Accordingly, an ongoing need exists to provide improved temperature monitoring within a reptile environment, so that the hobbyist can visually determine that proper temperature regulation has been achieved at one or a plurality of selected locations, and in particular one or a plurality of surface locations where a reptile may be located.

### DETAILED DESCRIPTION OF PREFERRED EMBODIMENTS

Thermochromic paint is understood as a coating that will change color when exposed to certain temperatures or temperature ranges. Such paints may therefore be formulated or selected to provide a color change at a selected temperature or temperature range.

Reptile species, which are cold-blooded animals, can vary depending upon species and size, but can thrive at temperatures in the range of 70° F. (21.1° C.) to 90° F. (32.2° C.), with basking areas that can reach over 100° F. (37.8° C.). For example, up to about 105° F. (40.6° C.). Preferably, the thermochromic paints may therefore be configured to indicate a selected color when the temperature within the reptile habitat, or on the surface of a component in the habitat, is within one or more of such temperature ranges.

Accordingly, the thermochromic paint is preferably one that undergoes a color change at a temperature in the preferred range of 57° F. (13.9° C.) to 105° F. (40.6° C.), more preferably 57° F. (13.9° C.) to 100° F. (37.8° C.) and even more preferably 70° F. (21.1° C.) to 100° F. (37.8° C.), including all individual values and increments therein. Identifying temperatures via a color change at such preferred temperatures or temperature ranges will therefore now be of important value to the reptile hobbyist, indicating by visual inspection where such temperatures are present within or on one or more surface of the reptile cage.

The present invention therefore stands directed at a reptile cage or habitat where one or more selected locations in the cage are configured to include a décor component having a thermochromic paint or coating, that provides the hobbyist with a relatively immediate and visual indication that the preferred temperature range for a particular reptile species is present. In addition, such thermochromic paint or coating may also provide an immediate and visual indication that a preferred temperature range for their particular reptile species is not present, so that the hobbyist can take necessary action to adjust the temperature range for the reptile’s benefit.

For example, one or a plurality of décor components at various locations in the reptile cage may be treated with thermochromic paint or coating, where the reptile is prone to isolate themselves on a particular warm spot or location. For example, the décor within the reptile cage, providing such surfaces, may be treated with a thermochromic paint to ensure that such spots are at a relatively higher temperature than other locations, yet still within the safe temperature range for the reptile species at issue. In this manner, the hobbyist is again provided with a visual indication that basking spot for the reptile at issue is available and maintained by the particular heating system for the reptile environment at issue.

It may therefore be appreciated that the reptile habitat may include a plurality of décor components, where one of the décor components having a surface coated with a thermochromic paint undergoes a color change at a first temperature (T1) and one of the décor components having a surface coated with a thermochromic paint undergoes a color change at a second temperature (T2), wherein T1 ≠ T2.

In addition, the thermochromic paint or coating herein may preferably be assigned color tones that enhance the visible indication that a desired temperature for the reptile is present. For example, selected décor of the reptile cage that is intended to provide a basking location may be configured to radiate a selected color that is different from a color indication at other locations in the cage. The thermochromic paint or coating herein is therefore preferably one that when reaching a temperature in the preferred range of 70° F. (21.1° C.) to 100° F. (40.6° C.), will undergo a color change and emit one or more of the following colors: yellow, purple, magenta, blue, red, or orange. One preferred thermochromic paint may be sourced from Guangzhou Shengcai Color Changing Material Co., Ltd., Baiyun District, Guangzhou.

Accordingly, the thermochromic paint or coating may be configured such that a selected color is present that coordinates and indicates that the cage is undergoing a heating cycle that is tuned for the reptile night cycle (i.e. a relatively cooler temperature range). In all situations, as noted, the thermochromic paint or coating is such that the hobbyist no longer needs to rely upon one or a plurality of thermometers, to ensure that the reptile habitat is at a temperature that optimizes the reptile’s biological functions.

In broad aspect, the present invention herein stands directed at a reptile habitat, containing one or more décor component surfaces therein comprising a thermochromatic paint or coating, wherein the thermochromatic paint or coating undergoes a color change to indicate a selected temperature (e.g., 70° F., 71° F., 72° F., 73° F., 74° F., 75° F., 76° F., 77° F., 78° F., 79° F., 80° F., 81° F., 82° F., 83° F., 84° F., 85° F., 86° F., 87° F., 88° F., 89° F., 90° F., 91° F., 92° F., 93° F., 94° F., 95° F., 96° F., 97° F., 98° F., 99° F., or 100° F.). The one or more décor component surfaces may also be configured to undergo a color change when reaching any temperature within the range of 70° F. to 100° F.

The preferred décor components of the habitat that may be provided with a thermochromic paint or coating may therefore include rock(s), wood, polymeric material, or ceramics. Reference to rock(s) is reference to any solid mass or aggregate of minerals or mineraloid matter. The décor components may include, e.g., sculpture type decorations that are typically utilized in the reptile habitat. Reference to reptile décor may broadly be understood as any component that is placed within a reptile cage to accommodate a reptile, to provide a location for the reptile to climb on and rest, which assists in the reptile’s ability to regulate their body temperature while exploring their environment. Such may therefore preferably include reptile basking platforms and reptile hideaways. Such décor will typically provide surfaces that can now be selectively coated with thermochromic paint to provide the ability of the user to, upon visual inspection, to understand what surface temperature may be present.

Finally, the relative surface area that is covered by the thermochromic paint here can be selected to optimize the viewing and detection that may be required by the user. For example, selected areas of the habitat décor may be provided with thermochromic paint that preferably measures 0.25 in² to 2.0 in², including all values and increments therein. Accordingly, the relative surface area of the thermochromic paint or coating herein can also be selectively adjusted within the habitat environment. Such surface area adjustment will therefore alter the size of the visual color indication of temperature regulation that the hobbyist may prefer within the habitat environment.

As may therefore now be appreciated, the present invention provides for the use of thermochromic material on reptile décor that can be utilized within a reptile cage or habitat that provide an indication of a temperature range therein, and in particular, a preferred surface temperature range at one or a plurality of locations.

What is claimed is:

1. A component for a reptile habit comprising a décor component having a surface coated with a thermochromic paint.

2. The décor component of claim 1 wherein said thermochromic paint undergoes a color change at a temperature in the range of 57° F. to 105° F.

3. The décor component of claim 1 wherein said thermochromic paint undergoes a color change at a temperature in the range of 70° F. to 100° F.

4. The décor component of claim 1 wherein 0.25 in²to 2.0 in² of said décor component surface is coated with a thermochromic paint.

5. The component of claim 1 wherein said décor component comprises rock, wood, polymeric material or ceramic.

6. A habitat for a reptile comprising one or a plurality of décor components having a surface coated with a thermochromic paint.

7. The habitat of claim 6 wherein said thermochromic paint undergoes a color change at a temperature in the range of 57° F. to 105° F.

8. The habitat of claim 6 wherein said thermochromic paint undergoes a color change at a temperature in the range of 70° F. to 100° F.

9. The habitat of claim 6 wherein 0.25 in² to 2.0 in² of said décor component surface is coated with a thermochromic paint.

10. The habitat of claim 6 wherein said décor component comprises rock, wood, polymeric material or ceramic.

11. The habitat of claim 6 wherein said habit has a plurality of décor components having a surface coated with a thermochromic paint.

12. The habit of claim 6 wherein one said décor components having a surface coated with a thermochromic paint undergoes a color change at a first temperature (T1) and one of said décor components having a surface coated with a thermochromic paint undergoes a color change at a second temperature (T2), wherein T1 ≠ T2.
